(19) United States
(12) Patent Application Publication
(10) Pub. No.: US 2019/0086630 A1
(43) Pub. Date: Mar. 21, 2019

(54) UNIVERSAL MOBILE PHONE LENS

(71) Applicant: MINGJUN ZHONG, Neijiang (CN)

(72) Inventor: MINGJUN ZHONG, Neijiang (CN)

(21) Appl. No.: 16/129,881

(22) Filed: Sep. 13, 2018

(30) Foreign Application Priority Data
Sep. 20, 2017 (CN) 201708549631

(51) Int. Cl. G02B 7/02; G02B 27/09; H04M 1/02; H04N 5/225

(52) U.S. Cl. CPC G02B 7/02; H04N 5/2254; H04M 1/0264; G02B 27/0972

(57) ABSTRACT

The invention discloses a universal mobile phone lens. The universal mobile phone lens comprises an objective lens module, sleeves, a prism module, a housing module, adjustment grooves and an ocular lens module; the sleeves comprise a first sleeve and a second sleeve; both the first sleeve and the second sleeve are hinged outside the housing module; the objective lens module and the ocular lens module are both installed inside the housing module; the prism module is installed inside the housing module and located between the objective lens module and the ocular lens module; the adjustment grooves are set outside the housing module; a sleeve groove is respectively formed inside the first sleeve and the second sleeve and is functioning with the adjustment grooves; and a stopper nail is arranged on the ocular lens module. According to the present invention, by rotating the first sleeve and the second sleeve, the objective lens module and the ocular lens module can be moved back and forth, and the distance between the ocular lens module and a mobile phone camera may be adjusted to work with different brands and models of mobile phones, henceforth, the device can be used in any kinds of cellphones, even in case of changing cellphones, it is no longer necessary to purchase a new special lens.

### FIELD OF THE INVENTION

The present invention relates to the field of mobile phone lenses, and more particularly, to a universal mobile phone lens.

### BACKGROUND OF THE INVENTION

At present, intelligent mobile phones have become a widely used device for youngsters, the middle-aged and even the elder. In the past, it was common for people to take along a vidicon or a camera when going out for travelling. Nowadays, the intelligent mobile phone is provided with not only a high-definition camera with millions and even tens of millions of pixels, but also a high-definition large screen. Various kinds of photographing software capable of high-definition photographing and recording together with photo beautifying functions are available. In this sense, except a professional, no one carries a heavy vidicon-camera set to go out for travelling and all can be done with an intelligent mobile phone weighing only 100 gram or slightly more. However, due to limitations in size of thin machine bodies of mobile phones, most phones are not equipped with an optical zooming function and only few mobile phones have a poor two-fold optical zooming function, which is far from satisfactory in case of photographing a distant view. Hence, there emerges a long lens dedicated for the mobile phones use (hereinafter referred to as a “special lens”) to make up the defect of no optical zooming or insufficient magnification, with which a high-definition distant view photo can be taken.

Emergence of the special lens has actually solved the problem that the camera that come with the mobile phone cannot be used to shoot a long-distance view. However, as there are numerous brands and models of mobile phones domestically and abroad, positions of the cameras are to be determined based on overall layout of each part of mobile phones, consequently, shapes and heights of cameras on different brands and models of mobile phones are not substantially the same, some of them are convex, some planar, even in case of convex cameras, protruding shapes and heights are different too. Therefore, distances between ocular lenses and the cameras of the special lenses are always different, which will in turn affect shooting effects of the cameras: in case that it is too long, a full screen photo cannot be taken; while too short, there will be shadow in four corners of the photos.

### BRIEF SUMMARY OF THE INVENTION

The present invention is intended to provide a universal mobile phone camera, so as to address the problems explained in the background.

To this end, a technical embodiment provided by the present invention is as follows. A universal mobile phone lens includes an objective lens module, sleeves, a prism module, a housing module, adjustment grooves and an ocular lens module; the sleeves include a first sleeve and a second sleeve; the adjustment grooves include a first adjustment groove and a second adjustment groove; both the first sleeve and the second sleeve are hinged outside the housing module; both the objective lens module and the ocular lens module are installed inside the housing module and they are respectively located at internal two ends of the housing module; the prism module is installed inside the housing module and is located between the objective lens module and the ocular lens module; the first adjustment groove and the second adjustment groove are both formed outside the housing module; a sleeve groove is respectively formed inside the first sleeve and the second sleeve; the sleeve grooves are functioning with the first adjustment groove and the second adjustment groove; and a stopper nail is respectively arranged on the ocular lens module and the objective lens module.

As a further embodiment of the present invention, the first adjustment groove and the second adjustment groove comprise respectively a rectangular groove parallel to a central line of the housing module; and the sleeve grooves respectively comprise a spiral groove.

As a further embodiment of the present invention, the first adjustment groove and the second adjustment groove comprises respectively a rectangular groove having an included angle with the central line of the housing module; and the sleeve grooves respectively comprise of a groove parallel to the central line of the housing module.

Compared with the prior art, the present invention achieves the following beneficial effects: the device is reasonably designed and its structure is simple; by rotating the first sleeve, the objective lens module can be moved back and forth so that definition of an image can be adjusted; while by rotating the second sleeve, the ocular lens module can be moved back and forth, and the distance between the ocular lens module and a mobile phone camera may be adjusted to work with different brands and models of mobile phones, henceforth, the device can be conveniently used in any kinds of cellphones, even in case of changing cellphones, it is no longer necessary to purchase a new special lens.

### BRIEF DESCRIPTION OF THE DRAWINGS

FIG. 1 is a structural schematic diagram of the universal mobile phone lens;

FIG. 2 is a section view taken along the A-A line in the first embodiment of the universal mobile phone lens;

FIG. 3 is a structural schematic diagram of the housing module in a first embodiment of the universal mobile phone lens;

FIG. 4 is a sectional diagram along an A-A direction in a second embodiment of a universal mobile phone lens;

FIG. 5 is a structural schematic diagram of a housing module in a second embodiment of a universal mobile phone lens.

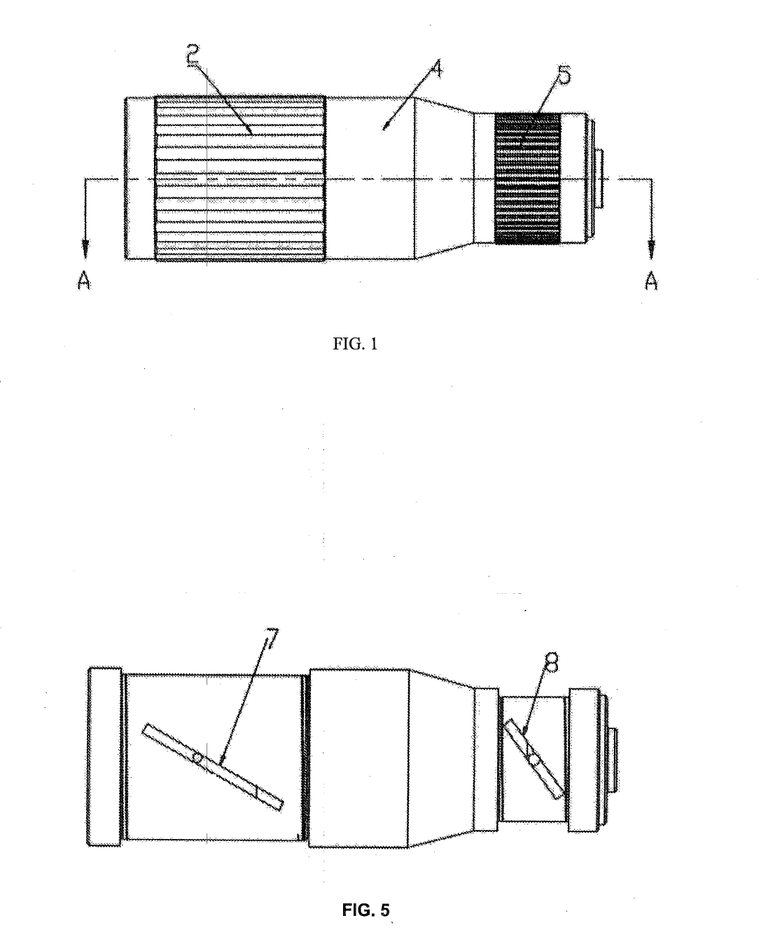

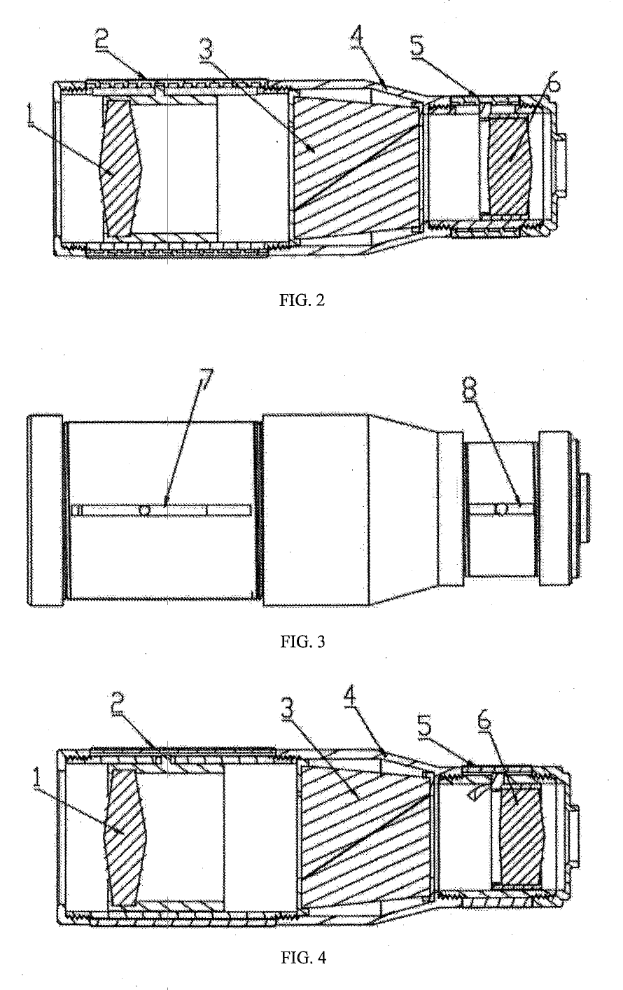

### DETAILED DESCRIPTION OF THE PREFERRED EMBODIMENT

The technical scheme of the present invention will be further described below in details with reference to specific embodiments.

### Embodiment 1

A universal mobile phone lens includes an objective lens module 1, sleeves, a prism module 3, a housing module 4, adjustment grooves and an ocular lens module 6; the sleeves include a first sleeve 2 and a second sleeve 5; the adjustment grooves include a first adjustment groove 7 and a second adjustment groove 8; the first sleeve 2 and the second sleeve 5 are both hinged outside the housing module 4; the objective lens module 1 and the ocular lens module 6 are installed inside the housing module 4 and they are respectively located at internal two ends of the housing module 4; the prism module 3 is installed inside the housing module 4 and is located between the objective lens module 1 and the ocular lens module 6; the first adjustment groove 7 and the second adjustment groove 8 are both formed outside the housing module 4; a sleeve groove is respectively formed inside the first sleeve 2 and the second sleeve 5; the sleeve grooves are functioning with the first adjustment groove 7 and the second adjustment groove 8; a stopper nail is respectively arranged on the ocular lens module 6 and the objective lens module 1; the first adjustment groove 7 and the second adjustment groove 8 comprise respectively a rectangular groove parallel to a central line of the housing module 4; and the sleeve grooves a spiral groove.

Under the interaction of the stopper nail on the ocular lens module 6, the second adjustment groove 8 on the housing module 4 and the sleeve grooves on each of the sleeves, when the first sleeve 2 or the second sleeve 5 is rotated, the objective lens module 1 or the ocular lens module 6 is moved forward or backward. With this structure, movement of the ocular lens module 6 can be minor and precise.

Light rays enter the prism module 3 from the objective lens module 1. The prism module 3 refracts the light rays to the ocular lens module 6. The ocular lens module 6 is connected with a mobile phone housing via a connecting hole. The objective lens module 1 may be adjusted so as to adjust the resolution of an image. The ocular lens module 6 may also be adjusted so as to adapt line of vision and wide angle of mobile phone cameras.

### Embodiment 2

A universal mobile phone lens includes an objective lens module 1, sleeves, a prism module 3, a housing module 4, adjustment grooves and an ocular lens module 6; the sleeves include a first sleeve 2 and a second sleeve 5; the adjustment grooves include a first adjustment groove 7 and a second adjustment groove 8; the first sleeve 2 and the second sleeve 5 both are hinged outside the housing module 4; the objective lens module 1 and the ocular lens module 6 both are installed inside the housing module 4 and they are respectively located at internal two ends of the housing module 4; the prism module 3 is installed inside the housing module 4 and is located between the objective lens module 1 and the ocular lens module 6; the first adjustment groove 7 and the second adjustment groove 8 are both formed outside the housing module 4; a sleeve groove is respectively formed inside the first sleeve 2 and the second sleeve 5; the sleeve grooves are functioning together with the first adjustment groove 7 and the second adjustment groove 8; a stopper nail is respectively arranged on the ocular lens module 6 and the objective lens module 1; the first adjustment groove 7 and the second adjustment groove 8 comprise respectively a rectangular groove having an included angle with a central line of the housing module 4; and the sleeve grooves comprises respectively a groove parallel to the central line of the housing module 4.

Under the interaction of the stopper nail on the ocular lens module 6, the second adjustment groove 8 on the housing module 4 and the sleeve groove on each of the sleeves, when the first sleeve 2 or the second sleeve 5 is rotated, the objective lens module 1 or the ocular lens module 6 is moved forward or backward. With such a structure, it is easy to machine all the components.

Light rays enter the prism module 3 from the objective lens module 1. The prism module 3 refracts the light rays to the ocular lens module 6. The ocular lens module 6 is connected with mobile phone housing via a connecting hole. The objective lens module 1 may be adjusted so as to adjust the resolution of an image. The ocular lens module 6 may also be adjusted so as to adapt to line of vision and wide angle of mobile phone cameras.

To a person skilled in the art, the present invention is obviously not limited to details of the above exemplary embodiments, and can be implemented in other specific forms without departing from the spirit or basic characteristics of the present invention. Therefore, at which point, the embodiments should be viewed to be exemplary and nonrestrictive. The scope of the present invention is not defined by the above description but the appended claims, and thus all changes fallen into connotation and scope of equivalent elements of the claims are included in the present invention. And all labels on accompanying drawings in the claims should not be seen as a limit to the appended claims.

In addition, it should be understood that, although the present invention is described according to embodiments, not all embodiments include only an independent technical scheme. The narrative way in the description is only for clarity. The person skilled in the art should view the description as a whole, and the technical scheme in each embodiment also may be combined properly to form other embodiments that may be understood by the person skilled in the art.

### REFERENCE NUMBERS IN THE DRAWINGS

1 objective lens module
2 first sleeve
3 prism module
4 housing module
5 second sleeve
6 ocular lens module
7 first adjustment
8 second adjustment groove

What is claimed is:

1. A universal mobile phone lens, comprising an objective lens module, sleeves, a prism module, a housing module, adjustment grooves and an ocular lens module, wherein the sleeves comprise a first sleeve and a second sleeve; the adjustment grooves comprise a first adjustment groove and a second adjustment groove; both the first sleeve and the second sleeve are hinged outside the housing module; the objective lens module and the ocular lens module are both installed inside the housing module, while they are respectively located internally at two ends of the housing module; the prism module is installed inside the housing module between the objective lens module and the ocular lens module; both the first adjustment groove and the second adjustment groove are formed outside the housing module; a sleeve groove is respectively formed inside the first sleeve and the second sleeve; the sleeve grooves are functioning together with the first adjustment groove and the second adjustment groove; and a stopper nail is respectively arranged on the ocular lens module and the objective lens module.

2. The universal mobile phone lens as in claim 1, wherein the first adjustment groove and the second adjustment groove comprise respectively a rectangular groove parallel to a central line of the housing module; and the sleeve grooves respectively comprise a spiral groove.

3. The universal mobile phone lens as in claim 1, wherein the first adjustment groove and the second adjustment groove comprises respectively a rectangular groove having an included angle with the central line of the housing module; and the sleeve grooves respectively comprise of a groove parallel to the central line of the housing module.
